(19) United States
(12) Patent Application Publication
(10) Pub. No.: US 2007/0207719 A1
(43) Pub. Date: Sep. 6, 2007

(54) Heater or Air Conditioner for a Vehicle

(75) Inventors: Rainer Blasi, Plochingen (DE); Alexander Bopp, Illingen (DE); Wolfgang Dieksander, Steinheim/Murr (DE); Alexander Schaudt, Tuttlingen-Nendingen (DE); Markus Wawzyniak, Rochester Hills, MI (US); Norman Schaake, Gottingen (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/578,073

(22) PCT Filed: Apr. 18, 2005
(86) PCT No.: PCT/EP05/04072

§ 371 Date: Oct. 12, 2006

(30) Foreign Application Priority Data
Apr. 23, 2004 (DE) 10 2004 020 415.2

(51) Int. Cl. B60S 1/54

(52) U.S. Cl. 454/121

(57) ABSTRACT

The invention relates to a heater or air conditioner comprising a mixing zone (M1) in which cold and hot air discharged from a cold air duct (K) and a hot air duct (W), respectively, are mixed. At least one second mixing zone (M2) is provided which is disposed downstream of the first mixing zone (M1) in the direction of air flow and to which cold and/or hot air can be delivered directly via a duct (K3; K3′; K3″) while the first mixing zone (M1) is bypassed. Also disclosed is a method for mixing air.

The invention relates to a heater or air-conditioning system for a vehicle according to the preamble of claim 1.

In order to make available conditioned air at a multiplicity of air outlets in the passenger compartment of a vehicle, air mixing and distributing devices are known with air ducts which usually have a central mixing zone to which warm and cold air are fed and from which ducts to the vents which feed the conditioned air to the passenger compartment of the vehicle branch off.

Such a heater or air-conditioning system therefore leaves room for improvement, in particular with respect to the maximum temperature which can be set.

The object of the invention is therefore to make available an improved heater or air-conditioning system.

This object is achieved by means of a heater or air-conditioning system having the features of claim 1. Advantageous refinements are the subject matter of the subclaims.

The invention provides a heater or air-conditioning system which has two mixing zones which are arranged one behind the other viewed in the direction of the air stream, it being possible to feed cold and/or warm air to the second mixing zone, bypassing the first mixing zone, via a duct. This permits optimum conditioning of the air, in particular stratification is possible.

The duct which bypasses the first mixing zone and is fed to the second mixing zone preferably branches off from one of the ducts which lead to the first mixing zone, preferably a cold air duct.

The duct which bypasses the first mixing zone preferably branches into at least two ducts which are preferably fed to different, second mixing zones, for example one on the driver's side and one on the front seat passenger's side, or to a second mixing zone which is assigned to the front region and/or a second mixing zone which is assigned to the rear region of the passenger compartment.

In order to equalize pressure and to increase the maximum available air flow rate, an equalizer flap is preferably arranged between the cold air duct and the warm air duct, preferably upstream of at least one blower.

The second mixing zone is preferably arranged downstream of at least one blower, it being possible for the blower to be, or to form, part of the first mixing zone.

A multiplicity of regulating devices are preferably provided for regulating the air supply to the mixing zones, said regulating devices preferably being formed by flaps, but other elements which regulate the air stream are also possible. The control is then preferably carried out on a centralized basis, and individual regulating devices can also be regulated by means of a common actuator drive.

The invention will be explained below in detail by means of a plurality of exemplary embodiments, partially with variants, and with reference to the drawing, in which:

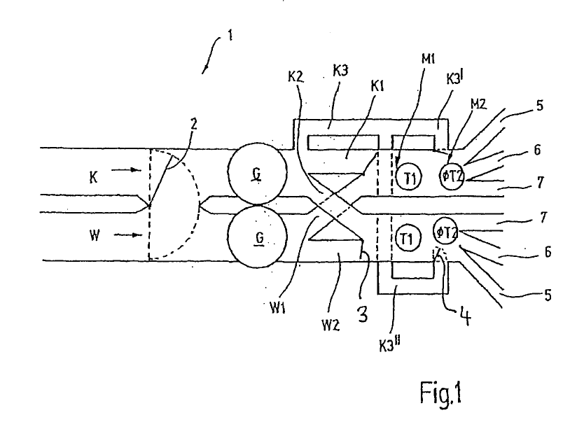

FIG. 1 shows a schematic view of a partial region of the ventilating system of a motor vehicle air-conditioning system according to the first exemplary embodiment,

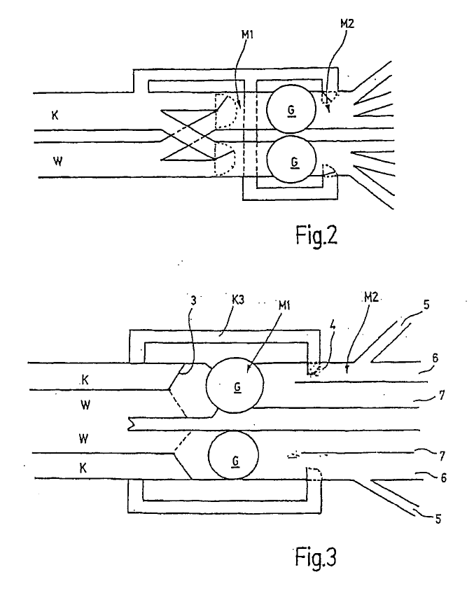

FIG. 2 shows a schematic view of a partial region of the ventilating system of a motor vehicle air-conditioning system according to the second exemplary embodiment,

FIG. 3 shows a schematic view of a partial region of the ventilating system of a motor vehicle air-conditioning system according to the third exemplary embodiment, and

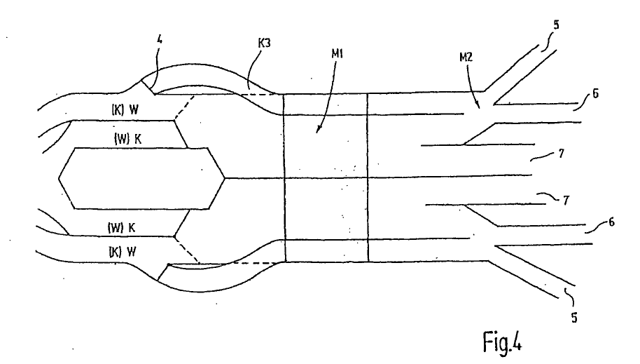

FIG. 4 shows a schematic view of a partial region of the ventilating system of a motor vehicle air-conditioning system according to the fourth exemplary embodiment.

A motor vehicle air-conditioning system 1 according to the first exemplary embodiment has, as illustrated in FIG. 1, a cold air duct K and a warm air duct W. An equalizer flap 2 for equalizing pressure is provided between the two ducts K and W. However, according to a variant which is not illustrated in the drawing the latter can be dispensed with.

A blower G is arranged in the cold air duct K and one is also arranged in the warm air duct W, respectively. The blowers G are each driven as required by a blower motor (not illustrated) and ensure that the airflow rate which is set by the user occurs at the air vents (not illustrated).

In an alternative embodiment (not illustrated), this function can also be fulfilled by means of a blower with two impeller wheels and a drive motor. A first impeller wheel is arranged here in the cold air duct K and a second impeller wheel is arranged in the warm air duct W. The two air streams are separated through the arrangement of a dividing wall in the blower housing between the impeller wheels. This can, for example, be permanently connected to the housing or be connected to the drive shaft of the impeller wheels as a circumferential dividing wall. Depending on the installation space available the drive motor can be located between the impeller wheels or outside them.

Downstream of the blower G, the respective air duct K or W branches, and according to the present exemplary embodiment the warm air duct W branches into two warm air ducts W1 and W2 with corresponding cross-sectional areas, and the cold air duct K branches into three cold air ducts K1, K2 and K3, with K1 and K2 having corresponding cross-sectional areas, and the third cold air duct K3 having a somewhat smaller cross-sectional area. This third cold air duct K3 in turn branches into two cold air ducts K3′ and K3″ having corresponding cross-sectional areas.

Owing to the corresponding embodiment of the downstream areas for the driver and front seat passenger with respect to the routing of ducts and the arrangement of mixing zones, only the region for the driver will be explained in more detail below.

The ducts W1 and K1 lead to a first mixing zone M1, it being possible to regulate the mixing ratio of the cold air and warm air by means of a flap 3, also referred to below as the first mixing flap. The air in the first mixing zone M1 has a temperature T1.

The first mixing zone M1 merges directly with the second mixing zone M2, the cold air duct K3′ being routed in the second mixing zone M2, regulated by a further flap 4.

Three outflow openings 5, 6 and 7 which are regulated by means of flaps (not illustrated) and by means of which the conditioned air is fed via further air ducts to the air vents and thus to the passenger compartment of the vehicle are provided adjacent to the second mixing zone M2.

The outflow opening 5 is assigned here to the air vent of the B pillar, and the outflow opening 6 is assigned to ventilation and the outflow opening 7 to the foot well. The outflow openings 5 for the air vent on the B pillar are each arranged—both on the driver's side and on the front seat passenger's side—as an extension of the cold air duct K1 and K2 which are respectively fed to the mixing zone M1 so that since generally complete mixture of the cold and warm air does not occur a certain stratification of the air is provided automatically. Although only partial mixture of the air takes place in the second mixing zone M2, reference is made to the central temperature as T2 with theoretical complete mixture of the air in the second mixing zone M2. Owing to the addition of cold air in the second mixing zone M2, the second temperature T2 is below the first temperature T1 in the first mixing zone M1.

The inflow opening of the cold air duct K3′ lies to the sides so that intensification of the stratification, in particular independently regulated stratification, of the air is possible and, owing to the arrangement of the outflow openings 5, 6 and 7 with respect to the inflow opening of the cold air duct K3′, colder air can be fed to the air vent of the B pillar than to the vent for ventilation and in particular to the vent in the foot well, but as a rule the “ventilation” and “foot well” temperatures essentially correspond to one another here. The same also applies to the front seat passenger's side.

The second exemplary embodiment illustrated in FIG. 2 corresponds essentially to the first exemplary embodiment but the blowers G are arranged between the first and second mixing zones M1 and M2, i.e. owing to the intermediate connection of the blowers G, which owing to its mixing function is also part of the mixing zone M1, there is no pre-stratification of the air and the two mixing zones M1 and M2 are spatially separated from one another. In addition, a blower which is not illustrated in the drawing is arranged in the bypass cold air duct, upstream of the branching of said duct, so that the pressure level of the cold air duct at the inflow opening corresponds at least to the pressure level prevailing in the mixing zone M2. Alternatively, in each case a blower can also be arranged downstream of the branching of the bypass cold air duct in each branch so that addition of cold air according to requirements is made possible.

According to one variant, the cross sections are configured in such a way that a partial vacuum prevails as a result of high flow rates at the inlet opening of the bypass cold air duct into the second mixing zone, and as a result cold air can pass into the second mixing zone when the flap is opened.

FIG. 3 shows a third exemplary embodiment according to which in each case a cold air or warm air duct K or W, respectively, leads to one of two blowers G. A bypass cold air duct K3 branches off from each of the cold air ducts K upstream of a flap 3 and the corresponding blower G. Owing to the symmetrical design, below reference is again made to just one side. The blower G and a small subsequent region serve as a first mixing zone M1. The air is then distributed between two channels, the air being fed directly to the foot well (outlet opening 7) via a duct. The duct K3 is fed laterally to the second duct which forms the second mixing zone M2 in the region between the first mixing zone M1 and the outlet openings 5 and 6, the air supply being regulated by means of a flap 4.

In order to equalize the pressure, there is a blower (not illustrated) in each of the bypass cold air ducts K3 corresponding to the second exemplary embodiment. In one refinement corresponding to the variant of the second exemplary embodiment these blowers can be dispensed with.

Owing to the arrangement of the inlet of the duct K3 in the second mixing zone M2, it is possible to stratify the air in accordance with the first and second exemplary embodiments so that the air fed into the passenger compartment of the vehicle in the region of the B pillar is colder with the desired stratification than the air fed into the ventilation means and in particular colder than the air fed into the foot well. The flaps for regulating the outflow openings 5, 6 and 7 are not illustrated.

The design according to the third exemplary embodiment permits optimum supply of the airflow rate in each temperature range.

The fourth exemplary embodiment illustrated in FIG. 4 corresponds essentially to the previously described third exemplary embodiment, but the blowers G are dispensed with so that reference is made to the third exemplary embodiment for more detailed explanation. The flap 4 for regulating the air flow through the duct K3 is arranged here at the inflow opening to the duct K3. In addition, additional stratification occurs by means of a configuration of the duct profiles which is different in depth.

In addition, FIG. 4 illustrates a variant according to which the warm air and cold air are fed in an interchanged fashion compared to the fourth exemplary embodiment.

### LIST OF REFERENCE SYMBOLS

1 Motor vehicle air-conditioning system
2 Equalizer flap
3 Flap
4 Flap
5 Outflow opening (B pillar)
6 Outflow opening (ventilation)
7 Outflow opening (foot well)
G Blower
K, K1, K2, K3, K3′, K3″Cold air duct
M1 First mixing zone
M2 Second mixing zone
T1, T2 Temperature
W, W1, W2 Warm air duct

1. A heater or air-conditioning system having a mixing zone in which cold and warm air respectively coming from a cold air duct or a warm air duct are mixed, wherein at least a second mixing zone is provided which is arranged downstream of the first mixing zone viewed in the direction of the air stream and to which cold and/or warm air can be fed directly, bypassing the first mixing zone, via a duct.

2. The heater or air-conditioning system as claimed in claim 1, wherein the duct branches off from the cold air duct or the warm air duct.

3. The heater or air-conditioning system as claimed in claim 1, wherein the duct branches off from the cold air duct.

4. The heater or air-conditioning system as claimed in claims 1, wherein the duct branches into at least two ducts.

5. The heater or air-conditioning system as claimed in one claim 1, wherein at least one blower is arranged in the duct.

6. The heater or air-conditioning system as claimed in claim 1, wherein an equalizer flap is arranged between the cold air duct and the warm air duct.

7. The heater or air-conditioning system as claimed in claim 6, wherein the equalizer flap is arranged upstream of at least one blower.

8. The heater or air-conditioning system as claimed in claim 1, wherein at least the second mixing zone is arranged downstream of at least one blower.

9. The heater or air-conditioning system as claimed in claim 1, wherein the first mixing zone is arranged upstream of at least one blower and/or is formed by the blower.

10. The heater or air-conditioning system as claimed in claim 1, wherein a multiplicity of regulating devices are provided for regulating the air supply to the mixing zones.

11. The heater or air-conditioning system as claimed in claim 1, wherein at least one regulating device is provided for regulating the airflow from the first mixing zone to the second mixing zone.

12. The heater or air-conditioning system as claimed in claim 1, wherein at least one regulating device is provided for regulating the airflow from the second mixing zone.

13. A method for mixing and distributing air in a heater or air-conditioning system for a motor vehicle, a mixing zone being provided for mixing and distributing air, warm and cold air which has a first temperature T1 are mixed in a first mixing zone, and subsequently further air with a temperature T2 is fed to the air with the temperature T1.

14. The method as claimed in claim 13, wherein the second temperature T2 is lower than the first temperature T1.

15. The method as claimed in claim 13, wherein the temperature mixing of air at the first temperature T1 and of the air at the second temperature T2 takes place incompletely so that stratification of the temperature occurs.

16. The method as claimed in claim 15, wherein the air is fed to the passenger compartment of the vehicle via ducts, at least the air which is fed to the foot well having a different temperature from the air which is fed to the other regions of the passenger compartment of the vehicle.

17. The method as claimed in claim 16, wherein the air which is fed to the foot well has a higher temperature than the air which is fed to the other regions of the passenger compartment of the vehicle.

18. The method as claimed in claim 13, wherein at least two air streams are mixed completely in a first mixing zone and the air which is fed from the first mixing zone to a second mixing zone is mixed at least partially or incompletely with one or more other air streams.
